(19) United States
(12) Patent Application Publication
(10) Pub. No.: US 2009/0046306 A1
(43) Pub. Date: Feb. 19, 2009

(54) Method and apparatus for ordering and printing annotated photographs

(76) Inventor: Darryl A. Green, Fredericksburg, VA (US)

Correspondence Address: Russ Weinzimmer, 614 Nashua St. #204, Milford, NH, 03055, US

(21) Appl. No.: 11/893,008

(22) Filed: Aug. 13, 2007

(51) Int. Cl. G06F 15/00

(52) U.S. Cl. 358/1.9

(57) ABSTRACT

A method and apparatus are disclosed for printing annotated digital photographs via a computer. Photographic data and annotation data are entered into the computer and associated with each other. The data are then transmitted to an image printing system, either across a network or via a direct connection, and the image printing system prints a double-sided print, with the photographic data on the front, and the annotation data on the rear. In preferred embodiments, metadata is associated with the image and annotation data, and the image and/or annotation data is stored on the computer. In another aspect of the invention, the annotation data is displayed on the computer together with the image, in lieu of producing a double-sided print. The annotation data can be prepared using the full range of editing and formating features of the graphical and text software available for the computer.

### FIELD OF INVENTION

This invention relates to photograph printing, and more particularly to systems for printing, displaying, and storing annotated photographic images.

### BACKGROUND OF THE INVENTION

As digital photography has gained in popularity, many websites have been created that provide digital image printing services. These websites allow users to upload digital photographic images and then select and order which images they want printed and mailed, or picked up in person. In addition, at many commercial locations devices are available that accept the input of digital photographs from a variety of storage media and print them locally within a few minutes. Also, there is a wide range of apparatus commercially available that is suitable for home-printing of digital photographs, typically through use of a home computer. Scanning apparatus and services are also readily available for converting photographs initially obtained and printed using conventional film technology into digital format.

While the storing and printing of digital photographs has become convenient, the process of annotating such prints has not. For example, to annotate a digital photographic print, the user must typically wait for the print to be printed or delivered, and then either attach a label to the print, store the print along with an annotated slip of paper, or write on the print.

Attaching a label to a print is problematic because the label can fade as the print is handled, or simply rub off over time. To retain annotations, the user must employ the time-consuming process of periodically monitoring the condition of the label on each print, and making necessary replacements as needed.

Another option involves the user storing prints in a photo album, and inserting annotated slips of paper with each print. The photo album protects the annotated slips, but manually organizing and annotating the slips of paper requires much time and effort. If each slip is placed in its own sleeve, then the storage capacity of the photo album is significantly decreased.

Alternatively, one can write an annotation on each photograph using a pen or marker. However, if the annotation is marked on the front of the print, it can distract from the image. If the annotation is written on the back of the print, the annotation can distract from the image by either bleeding through, or otherwise becoming visible when looking at the photograph. In addition to the cumbersome nature of writing an annotation on each photograph, the process can be very time consuming.

As another alternative, limited back printing options are offered on certain websites that enable a user to have some form of annotation information printed on the back of the photographic image. While these back printing options can help overcome the inconveniences of other forms of photograph annotation, they are limited in their ability to provide the annotation that the user wishes to create. The user is restricted to the options that the website provides, rather than having full control over the editing and formatting of the annotation information through their own personal text and image editing software.

Therefore, there is a need to provide the user with the ability to create a lasting print annotation that does not obstruct the view of the print, require excessive user effort or unduly complicate print storage. On the other hand, it is equally important that the user retain control over the image and annotation editing and formatting options, so as to arrange for an annotated print that fits well with the users's personal preferences.

### SUMMARY OF THE INVENTION

A method is disclosed that offers advantages over the prior art by providing an improved technique for the ordering and/or printing of annotated photographs via a computer system. This technique allows a user to place an annotation on the rear-surface of a photograph with little manual effort, using the full capabilities of the text and image editing software of their home or work computers. Another aspect of the invention allows for annotated photographs that have been edited on websites to be sent to personal computer systems, for storage and/or printing of the annotated photographs.

For each annotated photograph, the photographic image is printed on one surface of a double-sided print, while annotation is printed on the opposite surface. This placement of the annotation does not obscure the quality of the photograph and does not complicate the storage of the print. In some preferred embodiments, annotated images can be stored and displayed on a computer, such that the annotation is displayed automatically when the photographic image is displayed, or a convenient means is provided that causes the annotation to be displayed. For example, the annotation can be displayed in a “pop-up” box whenever the mouse cursor is placed somewhere over the photographic image.

More specifically, preferred embodiments disclosed herein provide for the printing of a 2-sided annotated photograph using a computer system, the computer system communicating with a printing system either across a network, a direct connection, or the internet. Photographic data and annotation data are entered into a computer system. An association between the annotation data and the photographic data is created within the computer system, and then the photographic data and the annotation data are transmitted to an image printing system.

The image printing system prints a double-sided print with the photograph on the front surface of the double-sided print and the annotation on the rear surface of the double-sided print. Preferred embodiments of the invention provide for transmitting the photographic data and the annotation data to an image printing system via a direct connection, through a network, or through the internet. Because the data entry and association takes place within the computer system, the user retains full control over data and graphical editing options. This allows the user to exercise a great degree of control in selecting such features as the size, format, and font of the annotation data.

The method of the present invention is explained in the context of digital photograph storage and printing. However, film photographic prints also can be scanned, and converted into digital images. Therefore, the invention also provides for the printing of annotated digital photographs that were once film photographs. Still other embodiments, advantages and aspects of the invention will become apparent by reading the following detailed description, and by reference to the drawings. Therefore, changes can be made to the particular embodiments described in the detailed description without departing from the spirit of the invention.

### BRIEF DESCRIPTION OF THE DRAWINGS

The invention will be more fully understood from the following detailed description, in conjunction with the accompanying figures, wherein:

FIG. 1 is a high-level block diagram of an embodiment of the invention employed via a computer network.

FIG. 2 is a high-level block diagram of an embodiment of the invention employed via a direct connection with an image printing system.

FIG. 3 depicts a diagram of an embodiment of the invention employed via a private computer network.

FIG. 4 depicts a diagram of an embodiment of the invention employed via the Internet.

FIG. 5 depicts a mid-level block diagram of an embodiment of the invention employed via a computer network.

FIG. 6 depicts a low-level block diagram of a computer system in accordance with the invention.

FIG. 7 is a flowchart illustrating a procedure for ordering and printing annotated photographs in accordance with the invention.

### DETAILED DESCRIPTION OF THE INVENTION

In the following detailed description of exemplary embodiments of the invention, reference is made to the accompanying drawings, which illustrate specific exemplary embodiments in which the invention can be practiced. These embodiments are described in sufficient detail to enable those skilled in the art to practice the invention. It is to be understood that other embodiments can be utilized and that logical, mechanical, electrical and other changes can be made without departing from the scope of the invention. Therefore, the following detailed description is not to be taken in a limiting sense, and the scope of the invention is limited only by the appended claims.

As used in this application, the terms “computer,” “system,” “server” or “computer system” are intended to refer to a computer-related entity, either hardware, a combination of hardware and software, software, or software in execution. For example, a computer system can be any organization of computer hardware and software implementing the invention. The computer system can be, but is not limited to being, a computing machine, a process running on a processor, a processor, an object, an executable, a thread of execution, a program, and/or a computer. For example, both an application running on a server, and the server itself, can qualify as components of a computer system. The computer system can be a general purpose computing device, including a system bus which couples together various system components, such as the coupling of a system memory to a processing unit. The computer system can comprise a single central processing unit (CPU), or alternatively, a plurality of processing units, together commonly referred to as a parallel processing environment.

A system bus can be any of several types of bus structures, including a memory bus or memory controller, a peripheral bus, and a local bus, using any of a variety of bus architectures. The system memory can include read only memory (ROM) and random access memory (RAM). A basic input/output system (BIOS), containing the basic routines that help to transfer information between elements within the computer system, such as during start-up, can be stored in the ROM.

While the invention has been described in the general context of computer-executable instructions of a computer program that runs on a computer and/or computers, those skilled in the art will recognize that the invention also can be implemented in combination with other program modules.

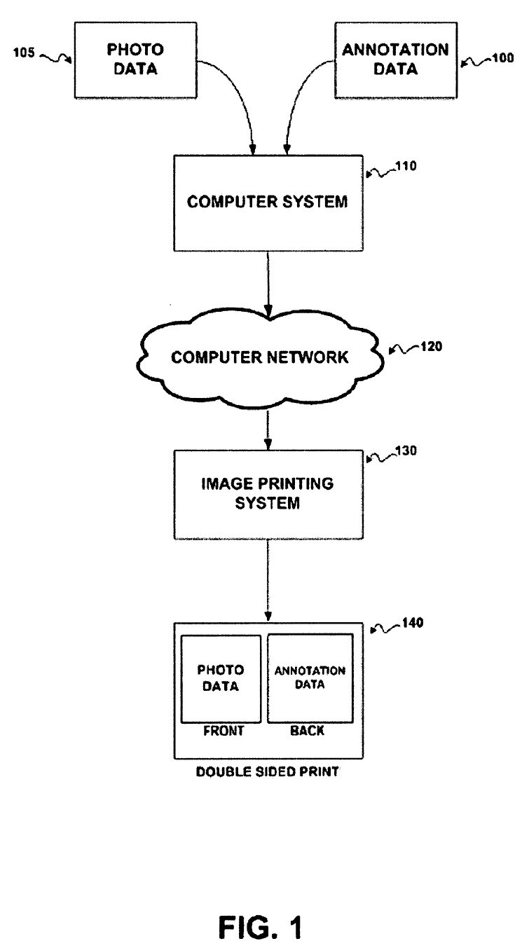

Referring to FIG. 1, a system for ordering and printing annotated photographs in accordance with the invention can include entry of annotation data 100 and photographic data 105 into a computer system 110, as described above. The computer system 110 can include any of a variety of drives and associated computer-readable media. The drives and associated media can provide non-volatile storage of computer-readable instructions, data structures, program modules and other data for the computer system.

Any type of computer-readable media which can store data that is accessible by a computer, such as magnetic cassettes, flash memory cards, digital video disks, random access memories (RAMs), and read only memories (ROMs), can be used in the exemplary operating environment. A variety of program modules and data can be stored in the computer system 110 by use of the drives and associated media. For example, such program modules can include an operating system, one or more application programs, software, and program data.

The computer system 110 can accept annotation data 100 and photographic data 105 from a user. As the annotation data 100 and the photographic data 105 are entered into the computer system 110, an association between the data 100, 105 is created. Both types of data 100, 105 are sent over a computer network 120 that connects with an image printing system 130.

As the image printing system 130 receives the annotation data 100 and the photographic data 105 via the computer network 120, the data 100, 105 is processed to initiate printing of a double-sided print 140. In doing so, the image printing system 130 can recognize that the annotation data 100 and the photographic data 105 are associated with each other and that the photographic data 105 is designated for the front surface of the double-sided print 140 and the annotation data 100 is designated for the rear surface. Based on the data 100, 105 and the aforementioned association, the image printing system 130 can print the double-sided print 140 with a representation of the photographic data 105 on the front surface of the double-sided print 140 and a representation of the annotation data 100 on the rear surface of the double-sided print 140. It is not necessary that the annotation data 100 and the photographic data 105 be sent over the computer network 120 during a specific span of time, since each type of data 100, 105 can be transmitted independently, and during different transmission sessions, between the computer system 110 and the image printing system 130. The image printing system 130 can include a double-sided printer that acts on the front and rear surface of the double-sided print simultaneously. Alternatively, the image printing system 130 can include a multi-pass printer that acts on the front and rear surface of the double-sided print at different stages.

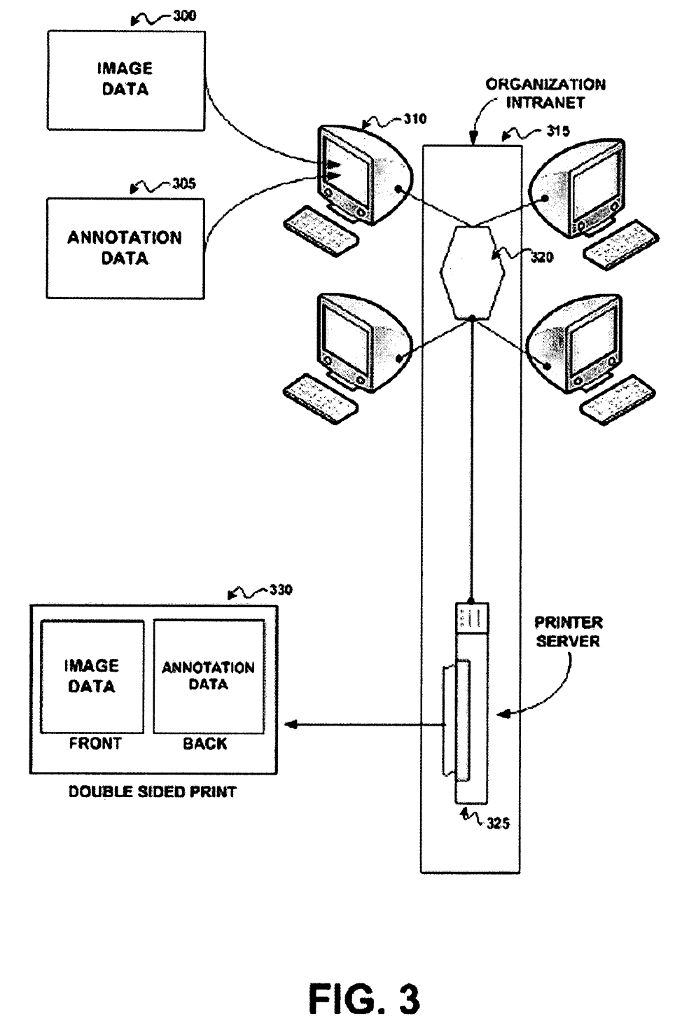

The computer network 120 can include a local area network (LAN), a wide area network (WAN) or another networking environment such as an enterprise-wide computer network, an Intranet or the Internet. When employed in a LAN networking environment, the computer system 110 can be connected to a local network through a network interface or adapter. When utilized in a WAN networking environment, the computer system 110 generally can include a modem, it can be connected to a communications server on a LAN, or it can have other means for establishing communications, such as the Internet. The modem, which can be internal or external, can be connected to a system bus via a serial port interface. In a networked environment, program modules or data can be stored in a remote memory storage device, or a server interacting with the computer system 110. It will be appreciated that the network connections shown in FIG. 1, as well as in FIGS. 3-6, are exemplary, and other means of establishing a communications link between the computers can be employed, such as a wireless connection.

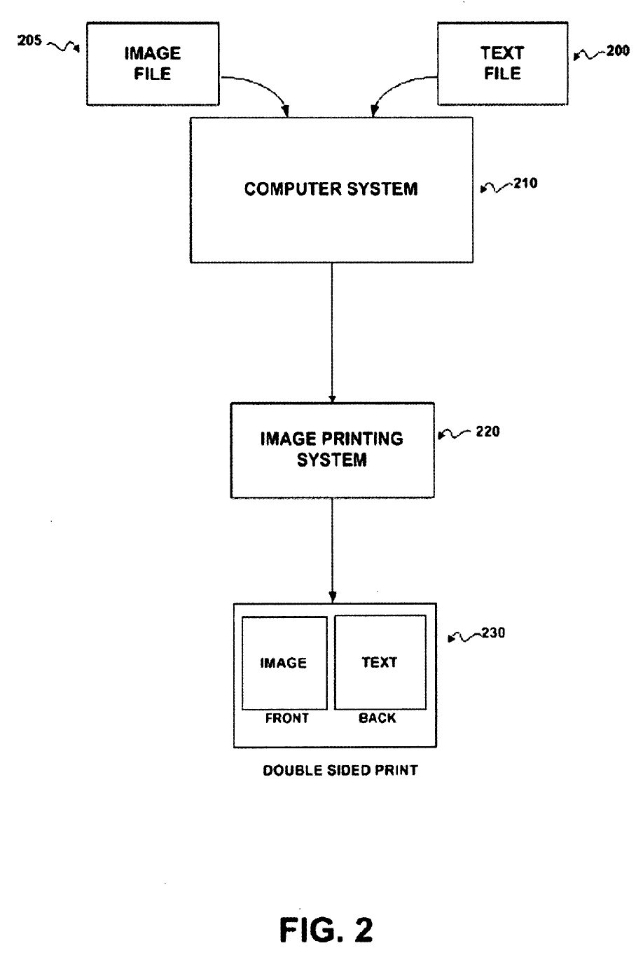

Referring to FIG. 2, a system for printing annotated photographs in accordance with the invention can accept a text file 200 and an image file 205 from a user into a computer system 210. As the text file 200 and the image file 205 are entered into the computer system 210, the computer system 210 can create an association between the data 200, 205. This association is further used to designate to the image processing system 220 that each of the data 200, 205 is intended for a particular surface of the same double-sided print 230. The data 200, 205 can be sent to the image printing system 220 via a direct connection, such as a Universal Serial Bus (U.S.B.) connection.

As the image printing system 220 receives the text file 200 and the image file 205 from the computer system 210, the data 200, 205 is processed and the image printing system 220 initiates printing of the double-sided print 230. The image printing system 220 receives commands and instructions from the computer system 210 as to the format of the double-sided print 230. The command and instructions communicate to the image printing system 220 that the text file 200 and the image file 205 are associated with each other, and that the image file 205 is designated for the front surface of the double-sided print 230, and the text file 200 is designated for the rear surface.

The image printing system 220 executes the commands and instructions to print the double-sided print 230 with a representation of the image from the image file 205 on the front surface of the double-sided print 230, and a representation of the text from the text file 200 on the rear surface of the double-sided print 230. It is understood that the commands and instructions that the image printing system 220 receives can be a string of characters, a bitmapped image, or a vector image of the text file 200 and/or the image file 205.

FIG. 3 depicts a diagram of an embodiment of the invention wherein the image data 300 and annotation data 305 are input into a computer 310 and transmitted via a private computer network 315. The private computer network 315 can be a secure network, an enterprise network, and/or an intranet. A person skilled in the art would recognize that the private computer network 315 can include a gateway with a firewall through which all access takes place, along with user authentication, encryption of messages, and the use of virtual private networks (VPNs). The embodiment of FIG. 3 includes one or more user computer systems 310 connected to a network hub 320. Linked to the network hub 320 is a printer server 325 that can print a double-sided print 330. The printer server 325 can be a host computer or computer device, to which one or more printers are connected, and which can accept print jobs from user computer systems connected to the printer server 325 via the private computer network 315. The printer server then can relay the data 300, 305 to a printer, which it manages. The printer server 325 provides printing protocol conversion from what was sent by a user computer system 310, to what will be accepted by a printer connected to the printer server 325. A variety of printing protocols include LPD/LPR over TCP/IP, NetWare, NetBIOS, NetBEUI, Port 9100 or RAW printer protocol over TCP/IP, DLC, or IPX/SPX.

A user can log onto the private computer network 315 via the computer system 310. The user can then upload the image data 300 and annotation data 305 from the user computer system 310 onto the private computer network 315. The data 300, 305 can be sent to the network hub 320 which can route the data 300, 305 to the printer server 325. As the data 300, 305 are uploaded at the user computer system 310, the data 300, 305 are processed so that there is an association created between the data 300, 305. Therefore, as the data 300, 305 is routed throughout the private computer network 315, the image data 300 and annotation data 305 can be identified as being related to each other.

The printer server 325 can receive the data 300, 305 sent over the private computer network 315 and can define a print job based on the data 300, 305 and the user computer system 310 that sent the data 300, 305 over the network. The print job can be placed in a queue and can be executed once an appropriate printer is available. Once the print job leaves the queue and is sent to a printer for execution, the printer can produce a double-sided print with the image on the front of the double-side print 330 and the annotation on the back of the double-sided print 330.

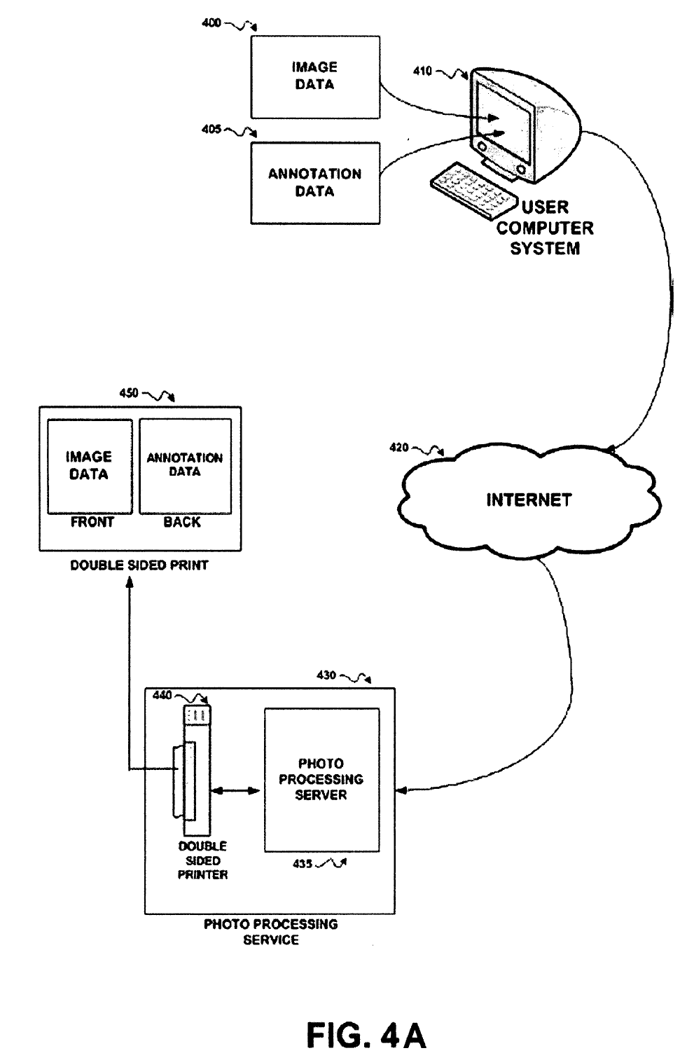

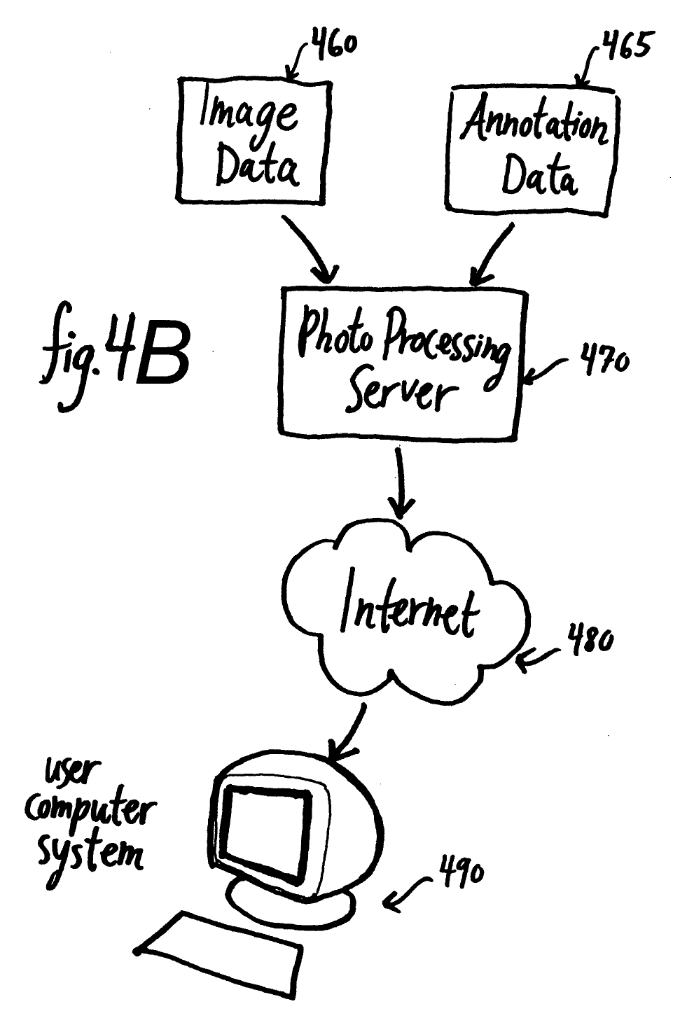

FIG. 4A portrays a diagram of an embodiment of the invention in which image data 400 and annotation data 405 are input into a computer 410 and transmitted via the Internet 420. As used in this document and as applied to FIG. 4A and FIG. 4B, the internet 420 employs a protocol in order to enable the transfer of data between one or more computers and/or servers. The lowest level of such a protocol includes I.P. (Internet Protocol), which defines the datagrams or packets that carry blocks of data from one node of the Internet to another. The next level of the protocol includes T.C.P. (Transmission Control Protocol) and/or U.D.P. (User Datagram Protocol), which are protocols by which one host sends data to another. T.C.P. can create a virtual connection. U.D.P. is a connectionless transport in which data packets that are lost in transit will not be re-sent. The higher level of the protocol includes application protocol. Application protocol defines the specific messages and data formats sent and understood by the applications running at each end of the communication.

A user can input the image data 400 and annotation data 405 into the computer system 410 using photo editing software, such as Adobe Photoshop, Microsoft Editor, or other computer-based photo editing software. The user can then log onto the Internet 420 via the computer system 410, and upload the image data 400 and annotation data 405 from the computer system 410 onto the Internet 420. The data 400, 405 can be sent over the Internet 420, and routed to a photo processing service 430, such as Shutterfly, Snapfish, Kodak, or another internet 420 processing service. The photo processing service 430 can store and/or process the data on a photo processing server 435, and then send it to a double sided printer 440.

As the data 400, 405 are uploaded at the user computer system 410, metadata can be created at the computer system 410. Metadata refers to data about data. Metadata can be information about a particular file, and/or data that provides context as to the administration, structure, use of the file, and the relationship of the file to another file. Metadata can be appended to or encoded into data, and/or can be transmitted over a network separately from the data it describes. Metadata includes, but is not limited to, identifiers (IDs), headers, addresses, footers, or other additional attributes related to data or the transmission of the data.

Metadata can be appended to the data 400, 405, so that there is an association created between the image data 400 and the annotation data 405. In addition, the metadata can also contain information regarding how the data 400, 405 can be reproduced on a double-sided print 450. There are many protocols that allow for creating and adding metadata to data and digital images. Such protocols are, for example: Extensible Metadata Platform, Exchangeable Image File Format, Tagged Image File Format, Dublin Core, Text Encoding Initiative, Encoded Archival Description, and METS (Metadata and Encoding Transmission Standard).

The photo processing service 430 can receive the data 400, 405 sent over the Internet 420, and can store the data 400, 405 at the photo processing server 435. Further, the photo processing service 430 can read the metadata and create printing instructions for the double-sided printer 440 based on the data 400, 405 and metadata. The printer 440 can process and execute the printing instructions in order to produce a double-sided print 450 with the image on the front surface of the double-side print 440, and the annotation on the back surface of the double-sided print 440.

Referring to FIG. 4B, image data 460 and annotation data 465, along with their associated metadata, can also be sent from the photo processing server 470 across a network 480 in the opposite direction. In this example, the invention is used to transfer the associated data 460, 465 back to a home computer 490 for further editing, storage, or printing. Image data 460 can be input, and an associated annotation 465 can be edited and formatted, at a photo processing server 470. Metadata can then be appended to the data at the photo processing server 470, creating an association between the image data 460 and annotation data 465. Next, the data 460, 465 can be sent across a network, such as the Internet 480, to a digital storage system such as the storage memory of a user's personal computer 490. The metadata can then be read at the computer system 490, where further editing and formatting, storage and archiving, or double-sided printing, can take place.

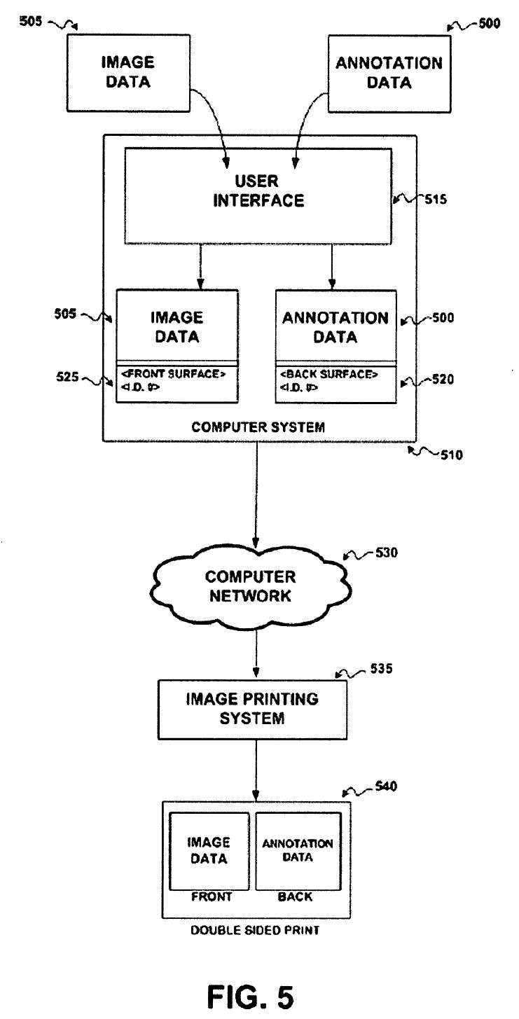

FIG. 5 displays a mid-level block diagram of an embodiment of the invention employed via a computer network. FIG. 5 includes annotation data 500 and image data 505 that are input into a computer system 510 through a user interface 515. The computer creates metadata 520, 525 that identifies the image data as front surface data 520, and the annotation data as rear surface data 525. The data is then transmitted via a computer network 530. The user interface 515 is portrayed as a component of the computer system 510. FIG. 5 also portrays the metadata 520, 525 as being created within the computer system 510. However, it is understood that metadata 520, 525 creation in accordance with the invention need not occur within the computer system 510. Instead, it can occur at the image printing system 535. The image printing system 535 is shown producing a double-sided print 540 according to the annotation data 500, the image data 505, and the metadata 520, 525.

The user interface 515 can prompt a user to enter annotation data 500 and image data 505. The user interface 515 can be a graphical user interface, a browser, a software window, and/or a view of a software application running on the computer system 510. The user can input the image data 505 into the computer system 510 via a menu and/or clickable buttons on the computer system 510. For example, the image data 505 can be a .JPEG of .GIF file that resides in the memory of the computer system 510. The user interface 515 can allow the user to browse various files, folders, and/or memory drives to identify and locate the saved image data 505. Since the invention uses software that is both compatible with a personal computer, and capable of providing full word processor features, a user has a great variety of formatting options. The user interface 515 can therefore allow for selections between various different colors, fonts, font sizes, line spacing, margins, and other such features, when inputting the annotation data 500.

The user interface 515 can provide guidance to the user with respect to the formatting of the annotation data 500. For example, at the time the user requests a double-sided print of an annotated photograph 540, the user interface 515 can show the user the available annotation space, in accordance with the size of the photo being printed. If the user wishes to annotate a 4×6 print, for instance, then a representation of the back of the 4×6 print can be presented, and a “What You See is What You Get” (WYSIWYG) representation of the annotation will be created, showing the user a representation of precisely how the annotation will be printed. The user interface 515 can also allow the user to determine the placement and positioning of the annotation on the back of the print. For example, the user can control where the annotation data 500 is located, such as middle centered, upper right, bottom left, and so on. Further, if the annotation data 500 exceeds the capacity for the selected size and formatting of the print, an error message can be shown to the user through the user interface, prompting the user to edit the annotation data 500. Such a message can instruct the user to change either the size, or formatting, of the annotation data 515, so that the annotation data 515 correctly conforms to the capacity of the print.

A user can enter commands and information through the user interface 515, by using input devices such as a keyboard and pointing device. Other input devices can include, for example, a microphone, mouse, joystick, game pad, satellite dish, or scanner. These and other input devices are often connected to a processing unit through a serial port that is coupled to the system bus. A monitor or other type of display device is also connected to the system bus.

The user interface 515 can provide basic default options for the editing of annotation information. For example, the user interface 515 can prompt a user to include “set specific” information, which is annotation data 500 that refers to the general setting within which the photograph was taken. “Set specific” information can include, for example, the occasion upon which the photograph was taken, as well as its date and location. Additionally, the user interface 515 can prompt the user to include “picture specific” information, which is annotation data 500 that refers to details of the particular photograph for which the image data 505 and annotation data 500 are being entered. “Picture specific” information can include the people featured in the photograph, and other information specific to the photograph in question. The user interface 515 can allow the user the option to include only one type of annotation data 500, and not another type of annotation data 500. For example, a user can choose to include “set specific” information, and not “picture specific” information, when inputting the annotation data 500 associated with a particular photograph. Such default options can facilitate the entry of annotation information for a set of related photographs, for which various aspects of the photograph can be the same. Folders can be established for a set or sets of individual photographs that are closely associated together, and are to be similarly annotated.

While “set specific” information can be used as annotation information for a group of photographs, “picture specific” information can also be applied to the individual photographs of the group. For example, the user can select a group of pictures, and input “set specific” information that will be placed on the back of each picture in the group of pictures. Then, in addition to the photo group annotation information, the user can further annotate any selected picture within the group of pictures, with more particular information about that specific selected picture.

Once the user has identified the image data 505, the user can initiate a transfer of the image data 505 from the memory of the computer system to the image printing system 535 via the user interface 515. Additionally, the user can enter annotation data 500 into the user interface 515 that the user wishes to appear with the image data 505 on the double-sided print 540. For instance, the user interface can present the user with a text input box that allows the user to directly enter annotation data 500 into the text input box of the user interface 515. After inputting the annotation data 500, the user can also initiate a transfer of the annotation data 500 from the user interface 515 to the image printing system 535.

The user interface creates metadata 520, 525 for the annotation data 500 and the image data 505. The metadata 520 associated with the image data 505 and the metadata 525 associated with the annotation data 500 are linked to the image data 505, and the annotation data 500, respectively. The metadata 520, 525 adds information to the annotation data 500 and the image data 505 by assigning attributes or tags. For example, a surface attribute can be encoded in the metadata 520, 525 that designates the image data 505 and the annotation data 500 for a specific surface of a double-sided print. As pictured in FIG. 5, the metadata 525 that is linked to the image data 505 assigns a ‘front surface’ attribute to the image data 505. For the annotation data 500, the metadata 520 designates a ‘back surface’ attribute. Furthermore, the metadata 520, 525 can contain a unique ‘I.D. #’ attribute that is common to both the image data 505 and annotation data 500. The shared unique ‘I.D. #’ attribute can create an association between the uploaded image data 505 and the uploaded annotation data 500. By sharing a unique ‘I.D. #’ attribute encoded in the metadata 520, 525, the image data and the annotation data are logically linked with each other. In addition, by having the surface attribute encoded in the metadata 520, 525, greater specificity is created regarding how both types of data 500, 505 relate to each other in the context of a double-sided print.

The image printing system 535 can receive the image data 505, the annotation data 500, and the metadata 520, 525 from the computer system 510 via the computer network 530. The image printing system 535 can include a server for storing and processing the data 500, 505, and metadata 520, 525. The image printing system 535 can access the metadata 520, 525 linked to the image data 505 and the annotation data 500 in order to affect efficient storage of the data 500, 505. For example, the image printing system can read the metadata 520, 525 and store both the image data 505 and the annotation data 500 each at a particular memory location within the server.

The image printing system 535 can recognize the metadata 520, 525 surface attribute that designates the image data 505 for a front surface of a double-sided print 540. In a lookup table defined for ‘front surface’ data, the image printing system 535 can store the unique ‘I.D. #’ attribute encoded in the metadata 525 linked to the image data 505 and can store the memory location of the image data 505. A similar algorithm can be used to store and process the annotation data 500. In a lookup data defined for ‘back surface’ data, the image printing system 535 can store the unique ‘I.D. #’ attribute encoded in the metadata 520 linked to the annotation data 500, and can store the memory location where the annotation data 500 is stored. It is understood that within each lookup table, the placement of the unique identifier attribute can map to the stored memory location, and vise-versa.

To process the image data 505 and the annotation data 500 for printing a double-sided print 540, a print request and/or a print command can include the value of the unique ‘I.D. #’ attribute. The image printing system 535 will access both look-up tables and search for a match for the unique ‘I.D. #’ attribute of the print request. Once the unique ‘I.D. #’ attribute of the print request is located in both the ‘front surface’ and the ‘back surface’ look-up tables, the image printing system 535 can read the memory locations in the look-up tables in order to know where to locate the previously stored image data 505 and annotation data 500. The image printing system 535 can copy the image data 505 and the annotation data 500 from their respective memory locations and process the data 500, 505 via, for example, a page description language.

The page description language can be compatible with a printer of the image printing system 535 and can contain commands and instructions to reproduce the data 500, 505 on a double-sided print 540. By accounting for which look-up table was used to locate the stored data 500, 505, the image printing system 535 can also communicate to the printer which data 500, 505 will go on the front and/or back surface of the double-sided print 540.

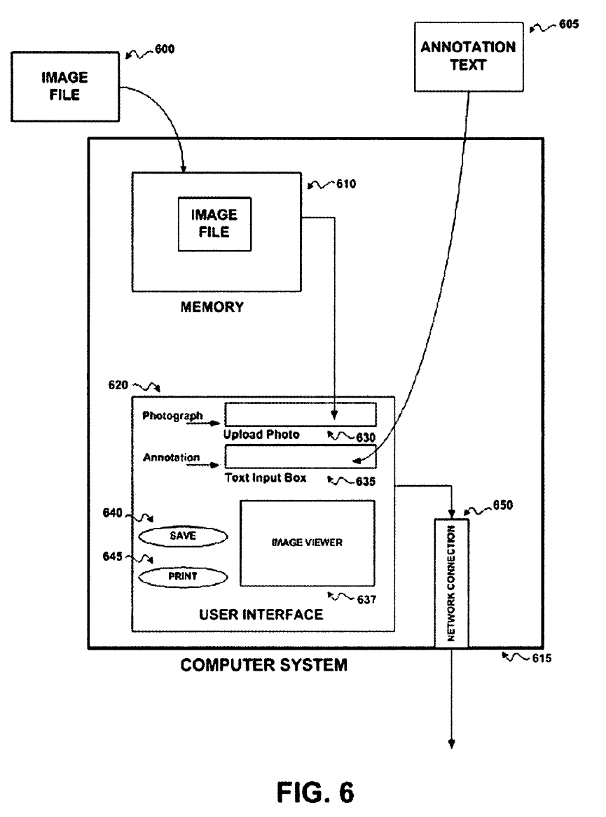

FIG. 6 shows a low-level block diagram of a computer system in accordance with an embodiment of the invention. Such a computer system 615, as depicted, can include a system memory 610, a user interface 620, and a network connection 650. Although not depicted, it is understood that the computer system 615 can include numerous software applications and external/internal computer devices and computing components.

A user can save an image file 600 and annotation text 605 into the memory 610 of the computer system 615. After a user has activated the user interface 620, the user can browse the computer system 615 for the image file 600 via an upload field 630 presented in the user interface 620. The upload field 630 can be identified in the user interface 620 as having “Upload Photo” functionality, such that the user knows how to instruct the user interface 620 to load a desired image file 600 from the memory 610. In addition, a text input field 635 is included in the user interface 620, allowing the user to directly input the annotation text 605. The text input field 635 can have accompanying information that informs the user that text entered as annotation text 605 will be an annotation for the image data 600 entered at field 630. It is understood that the user interface 620 can have a variety of options for inputting the annotation text 605 and the image file 600. The user interface can employ the following functionalities: drag-and-drop, a pop-up window, attachment, copy and paste.

The user interface 620 can provide for the displaying of annotation text 605 specific to the image file 600 it is associated with. This annotation text 605 can be displayed graphically when the associated image file 600 is highlighted or otherwise selected. This can provide a separate annotation method, as an alternative to the printing of the image file 600 with annotation text 605 printed on the back.

Further, the user interface 620 can include an image viewer 637 that displays the image that the user has selected to annotate. The image displayed in the image viewer 637 can be an image file 600 that is in the system memory 610. However, if the user wishes to annotate another image file that was previously uploaded to an image printing system, the image viewer 637 can display the previously uploaded image file, even though it resides at the image printing system.

FIG. 6 depicts two clickable buttons, “Save” 640 and “Print” 645, on the user interface 620. The “Save” button 640 can be employed to store the image file 610 and/or the annotation data 600 at the image printing system 535, shown in FIG. 5, or within the computer system 615. The “Print” button 645 can be employed to command an image printing system (such as 535, shown in FIG. 5), to print a double-sided print 540. However, references to these buttons 640, 645 are not meant to limit the amount or type of buttons and menus that can be included with the user interface. The user interface 620 can include text and/or menus that describe various actions available to the user. Additional exemplary options can include a photo-editing tool, a text tool to add embellishments to the annotation (e.g. underline, bold, font size), print purchasing selections, and purchase transaction selections. The user interface 620 can also be a plurality of graphical user interfaces, which can include pop-up windows, banners, active links (e.g. HTML), and dynamic content, for example.

The user interface 620 can execute an upload process for both the annotation text 600, and the image file 610, over a computer network via a network connection 650. As mentioned, the user interface can include software that creates metadata and links the metadata to the image file 610 and the annotation text 600. Therefore, the metadata is also sent over the computer network, and to the image printing system. It is to be understood that the software process that creates and links the metadata need not be exclusive to the user interface 620. For instance, such software can exist independently of the user interface 620, and can work in conjunction with the user interface 620 and other components and/or software throughout the computer system 615.

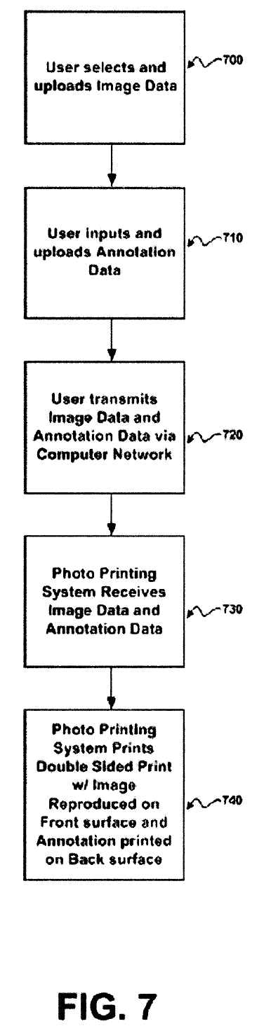

FIG. 7 is a flowchart illustrating a procedure for ordering and printing annotated photographs in accordance with one embodiment of the invention. At step 700, a user selects and uploads image data from a computer system onto a computer network. At step 710, the user inputs annotation data into the computer system and uploads the annotation data over the computer network. At step 720, the user transmits the image data and the annotation data over the computer network. At step 730, a photo printing system receives the image data and the annotation data from the computer network and the computer system. The photo printing system further stores and/or processes the image data and the annotation data. At step 740, the photo printing system prints a double-sided print, with the image on a front surface of the double-sided print, and the annotation on a back surface of the double-sided print. Although specific embodiments have been illustrated and described herein, it will be appreciated by those of ordinary skill in the art that any arrangement that is calculated to achieve the same purpose can be substituted for the specific embodiments shown. This application is intended to cover any adaptations or variations of the present invention. Therefore, it is manifestly intended that this invention be limited only by the following claims and the equivalents thereof.

What is claimed is:

1. A method for printing double-sided annotated photographs, the method comprising:
inputting photographic data into a computer system;
inputting annotation data into the computer system;
within the computer system, creating an association between the annotation data and the photographic data;
transmitting the photographic data and the annotation data to an image printing system; and
printing a double-sided print with the photographic data on a first surface of the double-sided print, and the annotation data on a second surface of the double-sided print.

2. The method of claim 1, further comprising at least one of editing and formatting the annotation data before the photographic data and the annotation data are transmitted to the image printing system.

3. The method of claim 1, wherein the photographic data and the annotation data are transmitted to the image printing system through a direct connection between the computer system and the image printing system.

4. The method of claim 3, wherein the direct connection is based on at least one of a serial connection, a parallel connection, a USB connection, and an infrared connection.

5. The method of claim 3, wherein transmitting the photographic data and the annotation data are transmitted to the image printing system by means of a printer driver.

6. The method of claim 1, wherein the photographic data and the annotation data are transmitted to the image printing system through a network.

7. The method of claim 1, wherein the photographic data and the annotation data are transmitted to the image printing system through the internet.

8. The method of claim 1, further comprising:
creating metadata related to the photographic data and the annotation data, the metadata designating the photographic data for the first surface of the double sided print and the annotation data for the second surface of the double-sided print, the metadata being created at one of the computer system system and the image printing system.

9. The method of claim 8, wherein the metadata is created at the computer system system and is transmitted to the image printing system in the same manner as the photographic data and the annotation data.

10. The method of claim 8, wherein the double-sided print is printed after processing of the metadata at the image printing system.

11. The method of claim 1, wherein printing the double-sided print includes processing by the image printing system of at least one of the photographic data for the first surface of the double-sided print and the annotation data for the second surface of the double-sided print.

12. The method of claim 1, wherein the photographic data and the annotation data are enetered into the computer system by means of a graphical user interface that includes at least one of an icon, a button, and a menu.

13. The method of claim 12, wherein the graphical user interface provides a graphical representation of available annotation space in which at least one of the size, formatting and style of the graphical representation is representative of the size, formatting and style, respectively, that are available for annotation printing.

14. The method of claim 1, wherein an error message is presented by the computer system if the annotation information entered exceeds the capacity for the size of the requested print.

15. The method of claim 1, further comprising entering general annotation data into the computer system, transmitting the general annotation data to the image printing system, and printing the general annotation data on the second surface of each of a plurality of double sided prints together with the annotation data that is specifically associated with the photographic data of each of the plurality of double sided prints,

16. The method of claim 1, wherein transmitting the photographic data includes compressing the photographic data according to an image compression algorythm.

17. The method of claim 1, wherein the annotation data includes at least one of alphanumeric text and graphic symbols.

18. The method of claim 1, wherein the double-sided print is printed by one of a double-sided printer and a multi-pass printer.

19. The method of claim 1, further comprising completing a purchase transaction that allows use of the image printing system.

20. The method of claim 1, further comprising;
saving at least one of the photographic data and the annotation data on the computer system.

21. A method for displaying annotation data associated with a photograph, the method comprising:
inputting photographic data into a computer system that is able to display photographic data;
inputting annotation data into the computer system;
within the computer system system, creating an association between the photographic data and the annotation data; and
when the photographic data is displayed, at least one of automatically displaying the annotation data that is associated with the photographic data and providing a convenient means for causing the annotation data that is associated with the photographic data to be displayed

22. A method for annotating photographs, the method comprising:
inputting photographic data into a photo processing system;
inputting annotation data into the photo processing system;
within the photo processing system, creating an association between the annotation data and the photographic data;
transmitting the photographic data and the annotation data to a computer system.

23. An apparatus for printing double-sided annotated photographs, the apparatus comprising:
a computer system;
an image printing system that is able to print on both sides of an image printable medium;
a connection between the computer system and the image printing system, the connection being able to transfer printable data from the computer system to the image printing system;
means for inputting photographic data into the computer system;
means for inputting annotation data into the computer system;
means for creating an association between the photographic data and the annotation data within the computer; and
means for recognizing the association between the photographic data and the annotation data within the image printer, so that the photographic data can be printed on one side of a printable medium and the annotation data can be printed on the other side of the printable medium.

24. The apparatus of claim 23, wherein the image printer is one of a double-sided printer and a multi-pass printer.

25. The apparatus of claim 23, wherein the connection between the computer system and the image printing system is a direct connection.

26. The apparatus of claim 23, wherein the connection between the computer system and the image printing system is a network connection.
